(19) United States
(12) Patent Application Publication
(10) Pub. No.: US 2012/0174406 A1
(43) Pub. Date: Jul. 12, 2012

(54) METHOD AND PRODUCTION PLANT FOR MAKING COMPONENTS FOR A MOTOR VEHICLE

(75) Inventors: Thomas Tröster, Salzkotten (DE); Thorsten Marten, Warburg (DE); Stefan Adelbert, Delbruck (DE); Otto Buschsieweke, Paderborn (DE)

(73) Assignee: Benteler Automobiltechnik GmbH, Paderborn (DE)

(21) Appl. No.: 13/181,960

(22) Filed: Jul. 13, 2011

(30) Foreign Application Priority Data
Jul. 14, 2010 (DE) 10 2010 027 179.9

(51) Int. Cl. B21D 53/88; B21D 31/00; C21D 9/00; F27B 15/00; F27B 5/16; F27B 9/04; F27D 3/00

(52) U.S. Cl. 29/897.2; 432/23; 72/342.94; 432/11; 432/58; 432/151; 432/200; 266/249; 148/559

(57) ABSTRACT

In a method of making a component for a motor vehicle, a metal part in the form of a plate, semifinished product, or a formed part, is heated in a fluidized bed of a fluidized bed furnace. The fluidized bed is being fluidized by a fluid, e.g. gas. Subsequently; the metal part is subjected to a forming, hardening or aging process.

### CROSS-REFERENCES TO RELATED APPLICATIONS

This application claims the priority of German Patent Application, Serial No. 10 2010 027 179.9, filed Jul. 14, 2010, pursuant to 35 U.S.C. 119(a)-(d), the content of which is incorporated herein by reference in its entirety as if fully set forth herein.

### BACKGROUND OF THE INVENTION

The present invention relates to a method and production plant for making components for a motor vehicle.

The following discussion of related art is provided to assist the reader in understanding the advantages of the invention, and is not to be construed as an admission that this related art is prior art to this invention.

Production of vehicle components involves the use of metal plates, semifinished metal products, or formed metal parts. The following description will generally refer to metal parts.

Metal sheets or plates of metallic alloys are normally hot formed or cold formed. To reduce weight and increase crash strength, the automobile industry increasingly uses high strength steel sheets that have been alloyed with boron and are hot formed and press hardened into formed parts.

Conventional heating processes for hot forming and press hardening of coated or uncoated plates differ in the way in which heat quantity is generated and transferred in the plate according to direct or indirect methods.

Direct methods may involve conduction and induction plants for heating. In these methods, the required heat amount for increase in temperature is generated directly in the plate so that the heating facilities can be designed relatively compact (part heating), and the efficiency of this plant construction is higher compared to indirect methods. However, this heating technique is disadvantageous because the heating result of the plate depends heavily on the plate geometry. In direct heating, for example by an induction or conduction furnace, adjustment of an even temperature profile in the plate to be heated is possible only to a limited degree. Thus, configuration of the plate geometry is limited, which means that basically only very simple geometries can be reliably heated and the presence of recesses or other cross sectional gradations should be avoided because of the possibility to encounter hotspots or possibly inadequate heating of the plate zone at these locations as a result of the presence of field lines in the plate so that an even temperature profile cannot be realized.

Moreover, ferromagnetic properties of steel alloys have a substantial impact on the efficiency during heating by induction. Once the Curie temperature is reached, the additional heat fraction is removed as a result of re-orientation of the Weiss domain so that the efficiency greatly deteriorates onwards of this temperature.

Indirect heating methods normally use conventional roller furnaces or revolving furnaces. Also high-power radiators can be used to heat the component surface to the desired temperature by radiant heat. Gas-operated roller or revolving furnaces have an efficiency of about 40 percent and are limited in their operation by the poor transmission capability of heat in the process. Also heating takes up much time so that the production cycle time can be ensured only when providing a substantial furnace stretch and substantial space for the used furnaces.

When the target temperature, for example hardening temperature, in the plate has been reached, the plate can be transferred to the next processing stage or may remain at the target temperature for a certain time to be able to compensate possible inhomogeneities in the material microstructure.

During production of motor vehicle components by hot forming and press hardening, the plate or a preformed semifinished product is advanced by a transfer unit in a following processing step to a forming and hardening station which normally includes hydraulic presses and tempered forming tools. The forming tool assumes the function of forming and targeted material hardening of the component or semifinished product being produced.

Heating of metal parts is an important aspect for hot forming and hardening. Conventional heating methods, as described above, have proven inadequate to attain a homogeneous temperature profile and to attain desired efficiency.

Motor vehicle components can also be produced by cold forming and subsequent hot treatment, for example to increase hardness, strength, or modification of the material microstructure. Heat treatment is also an important aspect in this method and influences the chronological sequence and the realization of a homogenous temperature distribution and thus quality of the component.

It would be desirable and advantageous to address prior art shortcomings and to provide an improved method and production plant for producing motor vehicle parts to ensure a rapid and even temperature distribution in the metal parts.

### SUMMARY OF THE INVENTION

According to one aspect of the present invention, a method of making a component for a motor vehicle includes the steps of heating a metal part in the form of a plate, semifinished product, or a formed part, in a fluidized bed, with the fluidized bed being fluidized by a fluid, and subjecting the metal part to a forming, hardening or ageing process.

According to another advantageous feature of the present invention, the fluidized bed can be fluidized by a fluid, such as gas or gas mixture. In this way, oxidation during heating of the metal part is reduced or eliminated altogether during heating. Advantageously, the metal part can be heated under an inert gas atmosphere in the fluidized bed furnace. The fluid may be heated before entry into the furnace chamber so that no heat energy is removed from the fluidized bed.

The present invention resolves prior art problems by heating a metal part in a separate retort or fluidized bed furnace with a fluidized bed, also called fluid bed, through which a fluid flows and which serves a heat exchanger. The retort is heated and circulated by a heated process gas and is filled with solid particles (process powder) as heat exchanger. The fluidized solid particles heated to a target temperature by the process gas and by the furnace temperature forms a fluidized bed having substantially thixotrope properties so that metal parts can be introduced into the fluidized bed of the retort for heating. The surface of the metal parts directly contacts hereby the fluidized bed and a steady heat exchange is established as a result of heat conduction between the contacting surfaces.

The heating step of the metal parts can be followed by a hot forming process, hardening process or ageing process. A metal part can be formed and/or certain areas thereof can be hardened in hot state after the heating process.

It is further possible, to form a metal part during three-dimensional cold forming and then to heat it in the fluidized bed furnace to the required process temperature. Heating may then be followed by a hardening operation through rapid cooling of at least some areas of the formed part or by an ageing process.

Advantageously, the fluidized bed furnace and its process chamber are heated. This may be realized by using a gas heat source or an inductive or conductive heat source. Combinations of heat sources are also possible.

Besides part heating of individual metal parts, it is, of course, also conceivable to heat several metal parts simultaneously or sequentially, when the fluidized bed furnace is filled with several parts. The cycle time of the downstream production line can thus be ensured.

In addition to the stationary disposition of the heated metal parts in the furnace, i.e. the metal parts are at rest in the fluidized bed, application of a run-through process may also be possible in which the metal parts are in motion in the fluidized bed during heating. Suitable transfer systems such as manipulator and transport devices can be provided and integrated in the furnace configuration.

The possibility to generate regions with different properties in the later motor vehicle part can be realized by changing the position of the metal parts in the fluidized bed furnace. As at least two regions with different temperature zones are implemented inside the furnace, the heated metal part can be heated to at least two different temperature levels. Advantageously, the fluidized bed may have a first zone at a temperature below the AC₁ temperature of a material of the metal part, and a second zone at a temperature above the AC₃ temperature of the material of the metal part. In this way, the downstream press hardening process can be implemented to provide a finished part for a tailored microstructure with different mechanical properties. For example, motor vehicle parts can be produced with at least two regions of different ductility or strength.

According to another advantageous feature of the present invention, the metal part can be heated in the fluidized bed furnace in multiple stages. This can be realized by controlling the temperature in the fluidized bed furnace or of the fluidized bed. The metal part may be pre-alloyed at a lower temperature which is then raised. It is also possible to provide a two-stage or multistage process with at least two fluidized bed furnaces which are switched sequentially, with different temperature levels being set in the fluidized bed furnaces.

The invention provides a homogenous heating of metal parts such as plates, semifinished products and/or formed parts in an optimal time specific for the part and subsequent manufacturing operations. This can be implemented in an economic manner and is also beneficial for the production of motor vehicle parts through hot forming and press hardening. The fluidized bed furnaces can be suited to the geometry of the metal part to be heated and configured in a space-saving manner. Heating of the metal parts is relatively quick so that the cycle time of subsequent operations, such as, for example, forming and hardening processes, is not significantly impacted.

Heating in a fluidized bed is applicable for metal parts of light metal, for example aluminum or aluminum alloys or magnesium or magnesium alloys, or also for those made of steel materials, for example high strength steel such as boron-alloyed steel.

According to another aspect of the present invention, a production plant for manufacturing a component for a motor vehicle includes a heating station for heating a metal part in the form of a plate, semifinished part, or formed part, the heating station including at least one fluidized bed furnace.

The fluidized bed involved here is a filling of solid particles which have been brought into a fluidized state by a fluid flow, in particular an upwardly directed fluid flow. Examples of fill material and solid particles include oxides or temperature-resistant oxidic minerals in powdery form or as pellets. Currently preferred is aluminum oxide, zirconium oxide, or silicon oxide. The filling and the solid particles are transformed into a fluid-like state or exhibit fluid-like properties in the fluidized bed furnace. As a result, a horizontal surface is continuously formed. This can be utilized to differently heat certain regions of the metal parts.

The solid particles are in intimate contact in the fluidized bed with the fluidizing medium and are intensely moved in all directions. This results in a good heat transport in the fluidized bed and in a good heat transfer between the fluidized bed and the metal parts to be heated. At the same time, the good heat transport and the high heat capacity of the fluidized bed provide for a homogenous temperature field in the fluidized bed furnace so that an even temperature distribution in the metal parts is realized.

According to another advantageous feature of the present invention, a forming device can be arranged upstream of the fluidized bed furnace. A plate can thus be used to produce a semifinished product or formed part by way of a forming process, in particular a cold forming process for subsequent heat treatment in the fluidized bed furnace.

According to another advantageous feature of the present invention, a forming device as well as a hardening device may be arranged downstream of the fluidized bed furnace. Suitably, a hot-forming and press-hardening device can be arranged downstream of the fluidized bed furnace. After being heated in the fluidized bed furnace, the metal part is transferred to the hot forming and press hardening device where it is hot formed and press hardened while being clamped in the tool.

The fluidized bed furnace is supplied with metal parts by a manipulator and transport device which immerses the metal parts in the fluidized bed and/or moved in the fluidized bed.

The fluidized bed in the fluidized bed furnace is generated by a fluid which causes a fluidized state of the solid particles. Advantageously, the fluid can be introduced at the bottom into the process chamber of the fluidized bed furnace via a diffusion plate.

According to another advantageous feature of the present invention, a pre-heater can be provided for preheating the fluid before being fed to the fluidized bed furnace. The fluidized bed furnace is thus heatable by a heating device. Effectiveness and energy efficiency of a production plant according to the present invention can be increased by insulating the outer walls of the fluidized bed furnace at least in some regions.

The fluid can be heated by conducting the fluid into the process chamber of the fluidized bed furnace in or at the walls of the fluidized bed furnace or even through the fluidized bed itself.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic cross section of one embodiment of a fluidized bed furnace with a metal part placed therein in one position;

FIG. 2 is a schematic cross section of the fluidized bed furnace of FIG. 1 with a metal part placed in a different position;

FIG. 3 is a schematic cross section of another embodiment of a fluidized bed furnace with a metal part placed therein in one position; and

FIG. 4 is a schematic illustration of a production line of a production plant according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

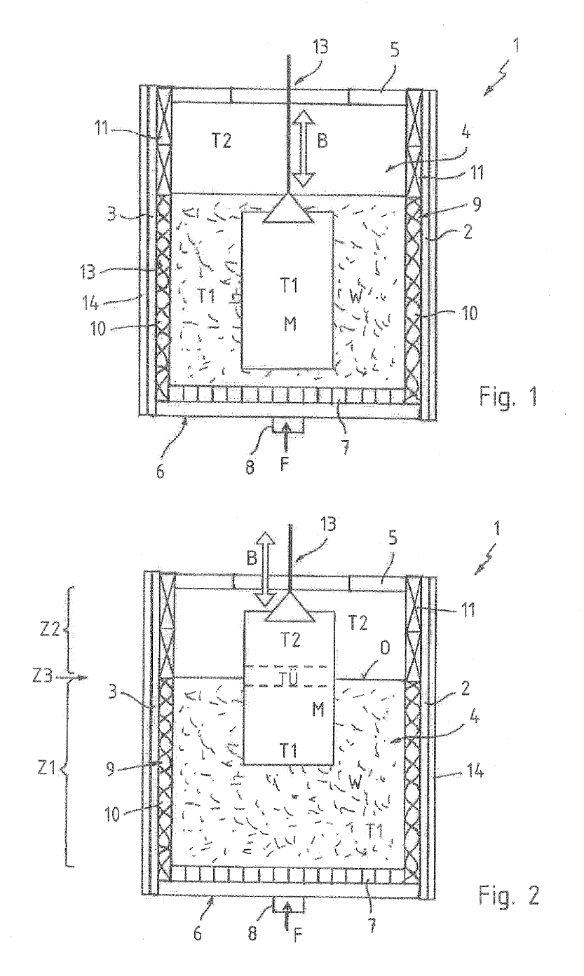

Turning now to the drawing, and in particular to FIG. 1, there is shown a schematic cross section of one embodiment of a fluidized bed furnace, generally designated by reference numeral 1. The fluidized bed furnace 1 includes a process chamber 4 which is bounded by outer walls 2, 3 and is covered by a lid 5. Arranged at the bottom 6 of the fluidized bed furnace 1 is a diffusion plate 7 via which a fluid (arrow F) can be introduced into the process chamber 4 of the fluidized bed furnace 1. The fluid F is supplied via an inlet 8, dispersed at the bottom 6, and enters the process chamber 4 via the diffusion plate 7.

A fluidized bed W of solid particles in the form of oxidized solid particles in powder or granulated state is provided in the process chamber 4. The fluidized bed W with the solid particles is heated in the process chamber 4 by a heating device 9 having heating elements 10, 11 arranged in the process chamber 4. The heating elements 10, 11 are installed on the inner sides 12 of the outer walls 2, 3. The heating elements 11 are arranged above the heating elements 10 and their operation is optional. Thus, the heating elements 11 can be added if necessary, depending on filling level of the solid particles in the fluidized bed furnace 1 and/or the desired temperature control.

The filling of solid particles in the process chamber 4 is brought into a fluidized state by the upward flow of fluid F so as to establish the fluidized bed W.

A metal part M, e.g. a plate, semi-finished product, or formed part of metal such as light metal or steel, is placed in the fluidized bed W and heated. FIG. 1 shows by way of example, the metal part M in the form of a plate.

A manipulator and transport device 13 is provided to place the metal part M in the fluidized bed furnace 1 and the fluidized bed W by grabbing the metal part M and introducing it from above into the fluidized bed W. The movement direction is indicated by arrow B.

A heat insulation 14 is attached to the outside of the outer walls 2, 3 to enhance efficiency and process economics.

The metal part M is heated in the fluidized bed W quickly and evenly to the required temperature. Subsequently, the metal part M is removed by the manipulator and transport device 13 and transferred for further processing, e.g. forming process, hardening process, especially forming and press hardening process, or also ageing process.

In the exemplified embodiment shown in FIG. 1, the metal part M is fully immersed in the fluidized bed W and thus evenly brought in its entirety to a temperature T1.

FIG. 2 shows a schematic cross section of the fluidized bed furnace 1 in which metal part M is placed only partially in the fluidized bed W. The horizontal surface of the fluidized bed W is designated by reference symbol O. As a result, a lower portion Z1 of the metal part M is heated to temperature T1, whereas an upper zone Z2 of the metal part M is heated to a temperature T2 which is lower than the temperature T1. A transition zone Z3 is established between the zones Z1, Z2 and heated to a transition temperature TÜ. In this way, temperature T1 in the first zone Z1 can be adjusted to a level above the AC₃ temperature of the material of the metal part M, and temperature T2 can be adjusted to a level below the AC₁ temperature of the material of the metal part M.

The metal part M can thus be maintained at different temperatures so that different properties, e.g. different ductility and strength, can be imparted in the zones Z1, Z2, Z3. This is provided in particular in those situations in which the metal part M is hot formed and press hardened at least in some areas thereof in a following processing step.

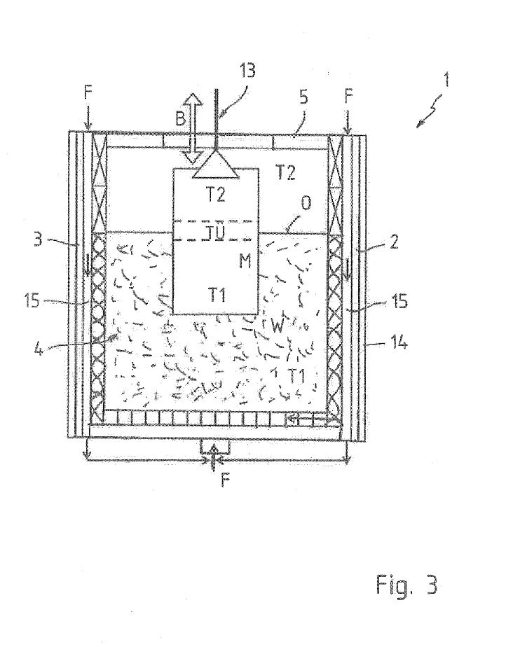

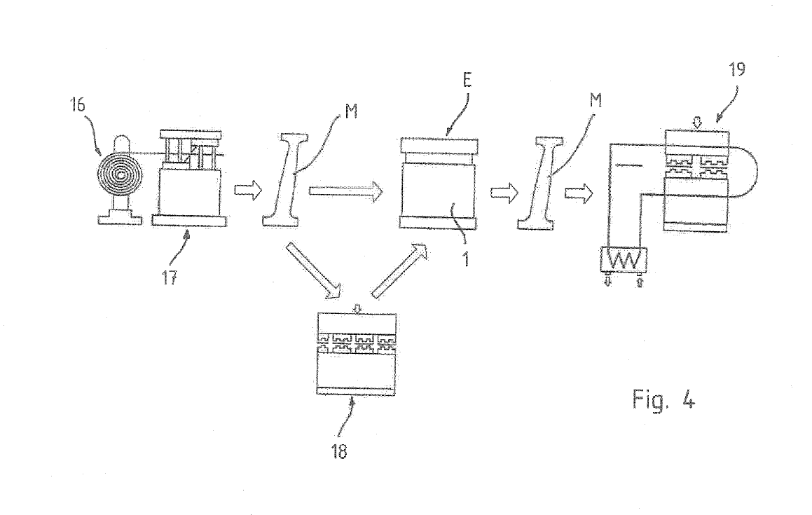

FIG. 3 shows a schematic cross section of another embodiment of a fluidized bed furnace 1. Parts corresponding with those in FIG. 1 are denoted by identical reference numerals and not explained again. The description below will center on the differences between the embodiments. In this embodiment, provision is made for passageways 15 between the outer walls 2, 3 for conducting fluid F on its way to the inlet 8 at the bottom 6. In this way, fluid F can be pre-heated or heated up.

Referring now to FIG. 4, there is shown a schematic illustration of a production line of a production plant according to the present invention for manufacturing motor vehicle part, such as structural or body components.

A coil 16 with a metal strip, made for example of a hardenable steel alloy, is rotated to pay out the metal strip which is then cut into single plates M in a cutting station 17. The plates M may optionally be preformed in a forming station 18 and/or trimmed. Cold forming normally involves deep drawing at room temperature. The plate M is trimmed to have a contour as close to a final shape as possible. The forming station 18 is optional and its presence depends on the complexity of the part geometry. In some applications, the forming station 18 may be omitted altogether.

The plate M is then transferred to a heating station E which involves a fluidized bed furnace 1, as described above with reference to FIGS. 1 to 3. The plate M is heated in the fluidized bed furnace 1 to the desired process temperature as a result of a direct contact with the fluidized bed W. Next, the plate M is removed from the fluidized bed furnace 1 for transfer to another processing stage, such as hot forming, hardening, or ageing.

In a production plant for producing hot formed and press hardened motor vehicle components, the plate M is heated in the fluidized bed furnace 1 to a temperature in a specific austenitizing temperature range of the material, i.e. to a temperature above the transformation temperature AC₁. Currently preferred is a temperature above AC₃. The heated plate M is then removed from the fluidized bed furnace 1 and transferred to a force-cooled hot forming and press hardening device 19 in which the plate M is formed and hardened at least in some regions thereof.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method of making a component for a motor vehicle, comprising the steps of:
heating a metal part in the form of a plate, semifinished product, or a formed part, in a fluidized bed, with the fluidized bed being fluidized by a fluid; and
subjecting the metal part to a forming, hardening or aging process.

2. The method of claim 1, wherein the fluid is a gas.

3. The method of claim 1, wherein the metal part is formed after the heating step, when still being warm.

4. The method of claim 1, wherein the heated metal part has at least one area which is hardened.

5. The method of claim 1, wherein the metal part has areas which are heated in the fluidized bed to different temperatures.

6. The method of claim 5, wherein the fluidized bed has a first zone at a temperature above an AC₃ temperature of a material of the metal part, and a second zone at a temperature below an AC₁ temperature of the material of the metal part.

7. The method of claim 1, wherein the fluid is heated before being introduced into the fluidized bed.

8. The method of claim 1, wherein the heating step is carried out under an inert gas atmosphere.

9. The method of claim 1, wherein the metal part is at rest in the fluidized bed during the heating step.

10. The method of claim 1, wherein the metal part is in motion in the fluidized bed during the heating step.

11. The method of claim 10, wherein the metal part is guided through the fluidized bed in a run-through process.

12. The method of claim 1, wherein the heating step is carried out in multiple stages.

13. The method of claim 1, wherein the component is a structural part or body part of the motor vehicle.

14. A production plant for manufacturing a component for a motor vehicle, comprising a heating station for heating a metal part in the form of a plate, semifinished part, or formed part, said heating station including at least one fluidized bed furnace.

15. The production plant of claim 14, further comprising a forming device arranged upstream of the fluidized bed furnace.

16. The production plant of claim 14, further comprising a hardening device arranged downstream of the fluidized bed furnace.

17. The production plant of claim 14, further comprising a hot-forming and press-hardening device arranged downstream of the fluidized bed furnace.

18. The production plant of claim 14, wherein the fluidized bed furnace includes a manipulator and transport device for disposition and/or movement of the metal part in the fluidized bed furnace.

19. The production plant of claim 14, wherein the fluidized bed furnace includes a diffusion plate for introduction of fluid into the fluidized bed furnace.

20. The production plant of claim 14, further comprising a pre-heater for preheating a fluid before being fed to the fluidized bed furnace.

21. The production plant of claim 14, wherein the fluidized bed furnace includes a heating device.

22. The production plant of claim 14, wherein the fluidized bed furnace has outer walls having at least some areas provided with a heat insulation.

23. The production plant of claim 14, wherein the fluidized bed furnace is constructed to allow temperature control.

24. The production plant of claim 14, wherein the heating station includes two of said fluidized bed furnace switched behind one another.
